(19) United States
(12) Patent Application Publication
(10) Pub. No.: US 2024/0111803 A1
(43) Pub. Date: Apr. 4, 2024

(54) DETECTING TARGET VEHICLES USING NON-STANDARD FEATURES

(71) Applicant: Panasonic Automotive Systems Company of America, Division of Panasonic Corporation of North America, PEACHTREE CITY, GA (US)

(72) Inventors: NIKSHEP PATIL, PEACHTREE CITY, GA (US); SATPREET SINGH, FAYETTEVILLE, GA (US)

(21) Appl. No.: 18/473,690

(22) Filed: Sep. 25, 2023

Related U.S. Application Data
(60) Provisional application No. 63/411,786, filed on Sep. 30, 2022.

(51) Int. Cl. G06F 16/583; G06V 10/70; G06V 20/62

(52) U.S. Cl. CPC G06F 16/583; G06V 10/70; G06V 20/625; G06V 2201/08

(57) ABSTRACT

Examples of the present disclosure relate to a system for detecting target vehicles. The system includes a sensor installed on a vehicle to sense light from outside the vehicle. The system includes a transceiver installed in the vehicle. The transceiver is to receive a detection request and transmit a detection output. The system includes a detection system installed in the vehicle. The detection system includes a processor to receive the detection request from the transceiver. The detection request includes non-standard features. The processor can also receive an image from a sensor. The processor can further execute a search on the image using the non-standard features in response to receiving the detection request. The processor can also send the detection output corresponding to a detected target vehicle to the transceiver.

### CROSS-REFERENCE TO RELATED APPLICATIONS

This application claims the benefit of U.S. Provisional Application No. 63/411,786, filed on Sep. 30, 2022, which the disclosure of which is hereby incorporated by reference in its entirety for all purposes.

### FIELD OF THE INVENTION

The present disclosure generally relates to techniques for implementing a vehicle detection system. More specifically, the present disclosure describes a vehicle with artificial intelligence (AI) based detectors.

### BACKGROUND

This section is intended to introduce the reader to various aspects of art, which may be related to various aspects of the present disclosure, which are described and/or claimed below. This discussion is believed to be helpful in providing the reader with background information to facilitate a better understanding of the various aspects of the present disclosure. Accordingly, it can be understood that these statements are to be read in this light, and not as admissions of prior art.

Various types of vehicle detection requests may be broadcast to large numbers of individuals in various forms. For example, vehicle detection requests may be sent in the form of Amber alerts, alerts in the form of emails or text messages, or in the form of general search requests in media, social media, etc. Such forms of target vehicle detection may depend on people noticing the vehicle of matching description and notifying the law enforcement.

In some cases, the vehicle detection requests may include standard features of target vehicles to be detected. For example, such standard features may include more one or more characteristics of vehicles, such as make, model, color, year, license plate or tag, etc.

### SUMMARY

Generally, the present techniques relate to a system for detecting vehicles. The system includes a sensor installed on the vehicle to sense light from outside the vehicle. The system also includes a transceiver installed in the vehicle. The transceiver is to receive a detection request and transmit a detection output. The system also further includes a detection system installed in the vehicle. The detection system includes a processor to receive the detection request from the transceiver. The detection request includes non-standard features. The detection system is to also receive an image from a sensor. The detection system is to execute a search on the image using the non-standard features in response to receiving the detection request. The detection system is to also further send the detection output corresponding to a detected target vehicle to the transceiver.

The present techniques further include a method for detecting target vehicles at a vehicle. The method includes receiving the detection request from a transceiver. The detection request includes non-standard features. The method further includes receiving an image from a sensor. The method further includes executing a search on the image using the non-standard features in response to receiving the detection request. The method further includes transmitting the detection output corresponding to a detected target vehicle to the transceiver.

The present techniques also include a system for detecting target vehicles. The system includes a processor. The processor is to receive a detection request from a transceiver, wherein the detection request includes non-standard features. The processor is to further receive an image from a sensor. The processor is to also execute a search on the image using the non-standard features in response to receiving the detection request. The processor is to further transmit detection output corresponding to a detected target vehicle via the transceiver.

### BRIEF DESCRIPTION OF THE DRAWINGS

The above-mentioned and other features and advantages of the present disclosure, and the manner of attaining them, may become apparent and be better understood by reference to the following description of one example of the disclosure in conjunction with the accompanying drawings, where:

FIG. 1 is a block diagram of an example environment for detecting target vehicles;

FIG. 2 is a diagram of an example vehicle receiving a detection request for detecting target vehicles, according to embodiments described herein;

FIG. 3 is another block diagram of an example system for detecting target vehicles, in accordance with embodiments;

FIG. 4 is a diagram of an example vehicle sending a detection output, according to embodiments described herein;

FIG. 5 is a block diagram of an example vehicle for detecting vehicles using non-standard features; and

FIG. 6 is a process flow diagram for an example method of detecting vehicles using non-standard features, in accordance with embodiments.

Correlating reference characters indicate correlating parts throughout the several views. The exemplifications set out herein illustrate examples of the disclosure, in one form, and such exemplifications are not to be construed as limiting in any manner the scope of the disclosure.

### DETAILED DESCRIPTION OF EXAMPLES

One or more specific examples of the present disclosure are described below. In an effort to provide a concise description of these examples, not all features of an actual implementation are described in the specification. It can be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it can be appreciated that such a development effort might be complex and time consuming, and is a routine undertaking of design, fabrication, and manufacture for those of ordinary skill having the benefit of this disclosure.

The present disclosure describes a system for detecting target vehicles. The system includes a processor to receive a detection request from a transceiver, wherein the detection request includes non-standard features. The processor can receive an image from a sensor. The processor can execute a search on the image using the non-standard features in response to receiving the detection request. The processor can then transmit detection output corresponding to a detected target vehicle via the transceiver. The system described herein can be configured to deliver any suitable type of support information such as video clips, location data, etc.

Accordingly, the techniques described herein may provide for more coverage area of search and detection than methods relying on human surveillance. Moreover, the techniques may provide more reliable and improved detection as compared to human detection. For example, AI-based feature detection may achieve better performance visually and acoustically than humans. In addition, the techniques may provide guaranteed detection notification sent to authorities. By contrast, humans may or may not report spotted vehicles for various reasons. In addition, the techniques may provide better detection than a simple vehicle plate-based or a/tag-based detection system. For example, vehicle plate details may not always be available in an incident. However, a description and/or images of target vehicle may be more likely to exist. Also, vehicle plate or tag may be changed easily. However, non-standard features such as dents, damage, rust, among other non-standard features, may be difficult to change quickly. The techniques may also provide performance that is than monitoring only with infrastructure cameras such as surveillance cameras at traffic intersections. For example, infrastructure cameras may only monitor at fixed locations and can thus be avoided by target vehicles. The techniques described herein deploy a large number of vehicles in a broad geographical region and may thus be more difficult to avoid. Moreover, other cameras such as store-front or residence cameras may not have the automatic detection and notification capability of the target vehicles. Manual inspection of recorded video may be not timely. Also, in real-life search requests examples, the available information on target vehicle may be varied from case to case. The techniques described herein provide an adaptable solution for varying inputs. For example, the provided inputs may be a description only, description and images, description with images and license plate or tag details, a license plate or tag with color and make and model, among other possible combinations of inputs. The techniques described herein may work well with varying amounts of such input data of different modalities, such as image, text, etc.

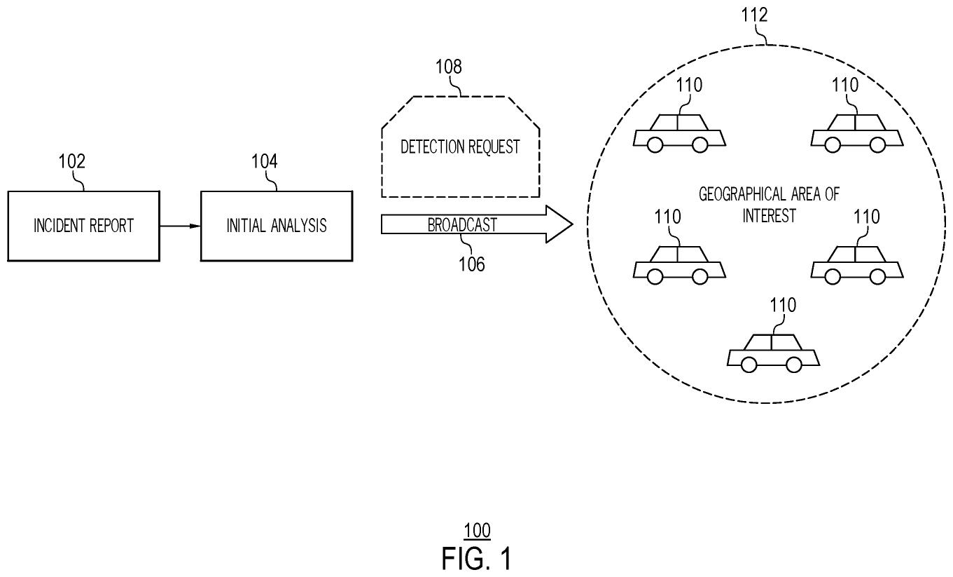

FIG. 1 is block diagram of an example environment 100 for detecting target vehicles. The environment 100 includes an incident report 102. For example, the incident report 102 may include a description of a target vehicle for searching. In various examples, the incident report 102 may include any number of non-standard features. For example, the non-standard features may include noticeable vehicle body features such as dents, scratches, rust, discoloration, or other damage to any portion of the target vehicle. The non-standard features may also include custom modifications. For example, the custom modifications may include the presence of after-market parts or modifications, such as graphics, spoiler, multiple paint tones, rear spoilers, custom grills, etc. In some examples, the non-standard features may be optional vehicle features, such as a sunroof or moonroof, alloy or steel wheels, wheel patterns, sedan versus coupe car type, etc. As one example, a non-standard feature may be damage to a side door. In another example, a non-standard feature may be a hood painted with a different color than the body. In yet another example, a non-standard feature may be the presence of a rear-spoiler on a vehicle.

The environment 100 also includes an initial analysis 104. For example, the initial analysis 104 may be performed on the incident report 102. In various examples, the initial analysis 104 may include detection of standard and non-standard features to be included in a broadcast detection request 108. For example, the initial analysis 104 may receive an incident report or detection request in any format and output a set of target vehicle features in a predefined format. For example, the initial analysis 104 may compile the details into a structured format that can be broadcast to the vehicles 110. In various examples, the structured format may be any suitable predefined format. For example, the format may be predefined by users of the environment 100.

The environment 100 also further includes a broadcast 106 of a detection request 108 to connected vehicles 110 in a geographical area of interest 112. For example, the detection request 108 may be pre-formatted and may describe any number of standard and non-standard features. In various examples, the connected vehicles 110 may be connected to a shared network, computing device, or service. As one example, the network may be a vehicle-to-everything (V2X) network that may enable vehicle-to-infrastructure (V2I) communications. In some examples, the geographical area of interest may be a geometric area centered on a particular location. For example, the location may be specified using geospatial global positioning (GPS) or any other suitable means. In various examples, the connected vehicles 110 may include automobiles, trucks, buses, motorcycles, drones, or any other vehicles connected to the network.

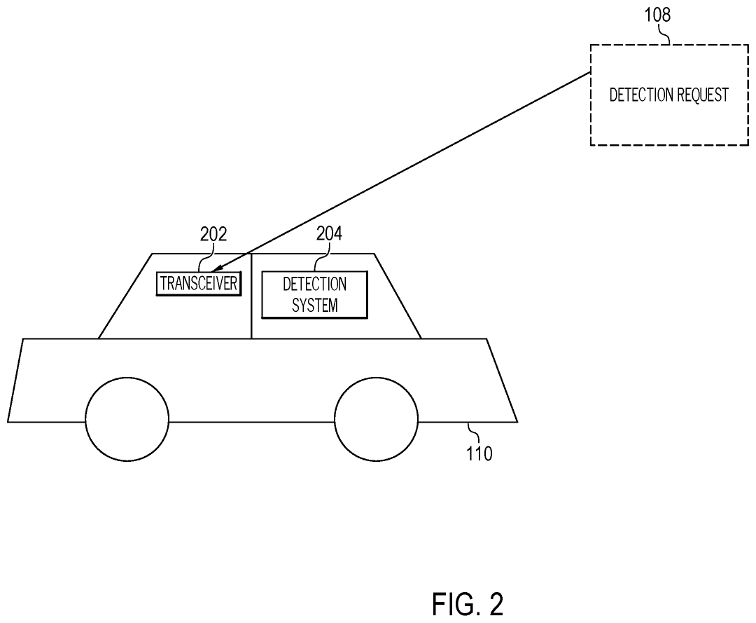

A detection system in the vehicles 110 may thus take target vehicle features in a predefined format as input. For example, the vehicles 110 may include the detection system described in FIGS. 2-4 below. In various examples, the target vehicle features may include non-standard features, such as vehicle dent, vehicle damage, discoloration, graphics, stickers, spoiler, modifications, rust, etc. In some examples, the vehicle features may also include standard features. For example, standard features may include license plate information, tag, make, model, etc. In various examples, the input can be in multiple formats. For example, a textual description of the vehicle may include any of the non-standard or standard features in a descriptive format. In some examples, the input may include images or video of the non-standard or standard features. In various examples, the vehicles 110 processes the detection request and perform surveillance using any number of sensors. For example, the sensors may provide an on-board camera, radio detection and ranging (RADAR), or light detection and ranging (LiDAR) feed. For example, the sensors may be located on the front, side, rear, or any combination thereof.

In various examples, the vehicles 110 can detect vehicles matching the features from on-vehicle camera, RADAR, or LiDAR feed. In various examples, the detection may be executed using any number of trained Artificial Intelligence (AI) based models. For example, a different model may be deployed for each type of input modality. Thus, a separate AI model may be trained for matching text descriptions, images and video, audio recordings, etc. In various examples, any suitable training techniques may be used for training. For example, gradient descent may be performed using stochastic gradient descent, batch gradient descent, mini-batch gradient descent. Such training may also use any suitable cost function, such as mean squared error (MSE), among others. In various examples, the AI models may be pre-trained and uploaded to the vehicles 110 on a periodic basis. The detection may be adaptive depending on the available types of input features. For example, any combination of pre-trained AI models may be used based on available input modalities. The vehicles 110 may thus be able to receive and process any available information of target vehicle.

In various examples, each of the pre-trained AI models may output a confidence score indicating the likelihood of a match of the associated input data with a target vehicle. In some examples, target vehicle may be detected in response to determining that one of the AI models generate a confidence score that exceeds a predetermined higher threshold. For example, a higher threshold may be set at a confidence score of at 0.75. In some examples, a target vehicle may be detected in response to determining that a lower threshold is exceeded by all of the applicable AI models. For example, a lower threshold may be a confidence score of 0.6.

In various examples, if a target vehicle of matching description is detected, then the vehicles 110 may automatically notify a predetermined destination. For example, the destination may be an authority. In some examples, the predetermined destination may be the source of the detection request 108. As one example, the connected vehicles 110 may automatically notify law enforcement if and when a target vehicle is located. In some examples, support information such as images, video, locations, of the target vehicle may also be sent by the vehicles 110. In various examples, the destination may thus receive notifications from any number of vehicles. In some examples, the destination may detect clusters of vehicles 110 reporting the target vehicle. For example, the destination may then decide to focus on a particular area, and review traffic cameras, among any other appropriate action.

As one specific example, an incident report 102 involving a vehicle may occur and details may be reported to law enforcement, or any other equivalent entity. Law enforcement may then compile relevant details of the target vehicle. The details of such initial analysis 104 may include non-standard details of the target vehicle as discussed above. For completeness, standard details such as license plate, tag, make, or model can also be included if available. The details are broadcast 106 to all other vehicles 110 in the geographical area of interest 112 via a detection request 108 using V2X channels. Connected vehicles 110 may thus receive target vehicle details. These details are utilized by a detection system running on-board, such as the detection system described in FIGS. 2-4. The detection system may start monitoring surroundings for matching vehicles using its camera feed. If a vehicle matching provided description is found, then the vehicles 110 dispatch a notification to law-enforcement. The notification may include image/video, location, among other details of the target vehicle. Law-enforcement may then take further actions based on detection notifications received by vehicles 110.

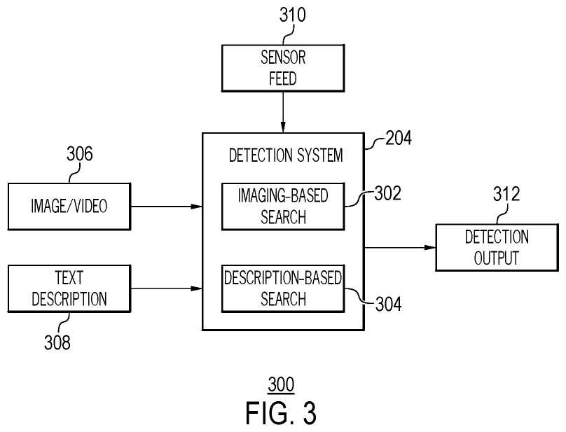

FIG. 2 is a diagram of an example vehicle receiving a detection request for detecting target vehicles, according to embodiments described herein. The vehicle 110 includes a transceiver 202. For example, the transceiver 202 may be any suitable wireless communication device, such as a V2X transceiver. The vehicle 110 further includes a detection system 204. For example, the detection system 204 may utilize any processor of vehicle 110, such as any graphics processing unit (GPU), neural processing unit (NPU), etc. An example operation of the detection system 204 is described in greater detail in FIG. 3.

In the example of FIG. 2, a detection request 108 is received by the transceiver 202 of the vehicle 110. For example, the vehicle 110 may be within a geographical area of interest for a particular target vehicle. The detection system 204 may thus receive the detection request 108 and process incoming image or video feeds as described herein to search for the target vehicle.

FIG. 3 is another block diagram of an example system for detecting target vehicles, in accordance with embodiments. The system 300 may be implemented in any suitable vehicle, such as the connected vehicles 110 of FIGS. 1, 2, 4, and 5. The system 300 includes the detection system 204 of FIG. 2. The detection system 204 also includes an imaging-based search module 302 and a description-based search module 304. The system 300 includes an input image/video 306 and a text description 308. For example, the input image/video 306 and a text description 308 may be received in a detection request. The image/video 306 may be an image or video containing multiple frames of a target vehicle. The text description 308 may include a textual description of one or more non-standard features of the target vehicle. In some examples, the text description 308 may also additionally include a description of standard features.

In various examples, the detection system 204 is activated on receiving a detection request including the image/video 306, text description 308, or both, and may start monitoring surroundings using built-in cameras, RADAR, LiDAR, or any other suitable imaging technique. The detection system 204 may thus receive as input details of the target object such as image or video 306 and text description 308, in addition to a continuous sensor feed 310 of the vehicle. For example, the sensor feed 310 may be received from image sensors, LiDAR sensors, RADAR sensors, or any other sensor from a perception subsystem of a vehicle. In some examples, the detection system 204 may be an AI based detection system. For example, the AI-based detection system may employ a multi-modal learning based classification. In various examples, the AI based detection system may include multiple pre-trained models that take detection requests in a predefined format. For example, a separate model may be trained for each input modality, such as text description 308, image/video 306, etc., of a target vehicle. In various examples, the AI models may be pre-trained to detect target vehicles based on non-standard features. In some examples, the AI models may also be pre-trained to detect target vehicles based on standard features. For example, the non-standard or standard features can be derived manually or automatically based on an input image, video, or text-description.

In various examples, an AI-based detection system 204 may utilize any suitable supervised or unsupervised learning methods. In addition, the AI-based detection system 204 may employ any suitable supervised or unsupervised machine learning, deep learning, reinforcement learning techniques, or any combination of these techniques. For example, deep learning techniques may automatically derive features for training the AI models. In various examples, received video 306 may be converted into images for detection purposes. For example, received videos 306 may be converted into images 306 and each image processed using the imaging-based search module 302 with the sensor feed 310 to detect target vehicles. As one example, the imaging-based search module 302 may be any suitable neural network trained using images to detect similar images. For example, the imaging-based search module 302 may be a neural network that generates non-standard features from provided image/video 306 and matches the non-standard features with frames from the sensor feed 310. In some example, the frames from a camera feed, a LiDAR feed, and a RADAR feed may be combined to provide more accurate data about non-standard features present in a particular scene. For example, the LiDAR and RADAR depth information may provide more accurate information about the presence of dents or other non-standard surface features of a target vehicle. In various examples, the AI-based detection models may be pre-trained binary classifiers that classify each image or frame into a positive class or negative class based on the non-standard features provided by a particular associated input modality. For each positive class, the models may also output an associated confidence score.

In various example, the description-based search 304 may similarly be any suitable neural network trained using annotated images to match text descriptions to particular images. For example, the description-based search 304 may detect frames of the sensor feed 310 that include one or more non-standard features described by text. As one example, for the non-standard feature described by “driver door damage” an associated AI model may be trained on thousands of images with damage on a driver's side door.

Once a target vehicle is detected, the detection system 204 can provide a detection output notification with support details. In various examples, the detection output may include a confidence score and support information, such as encrypted video or image evidence, textual report, location, or any other support information.

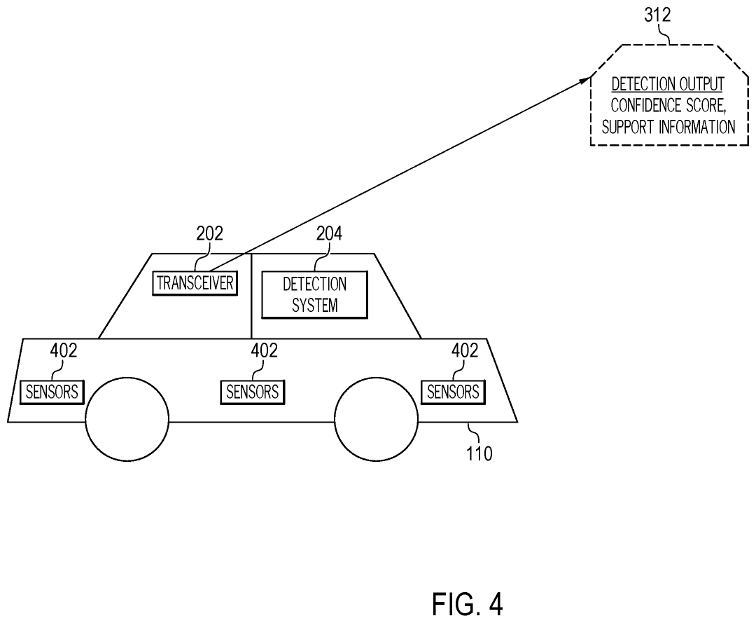

FIG. 4 is a diagram of an example vehicle sending a detection output, according to embodiments described herein. The example connected vehicle 110 includes a transceiver 202 and detection system 204, as described in FIG. 2. The connected vehicle is shown outputting detection output 312, as described in FIG. 3. The example connected vehicle 110 further includes a number of sensors 402. For example, the sensors may be image sensors, LiDAR sensors, RADAR sensors, or any other sensor from a perception subsystem (not shown) of the connected vehicle 110. The image sensors may provide two dimensional images of light outside the vehicle 110. The LiDAR and RADAR may provide depth information about surfaces outside the vehicle 110. In various examples, the sensors 402 may be any number of cameras installed in the vehicle 110. For example, the vehicle 110 may have from one to six cameras pre-installed in any number of directions. In various examples, any number of cameras may be pre-installed in vehicle 110. As one example, the sensors 402 may be installed in the vehicle for another purpose, such as automated or assisted vehicle navigation. In the example of FIG. 4, the vehicle 110 is shown with sensors 402 installed in the front, the back, and on one side of the vehicle 110. In various examples, the sensors 402 may provide a continuous incoming feed of sensor data to the detection system 204.

As described in greater detail with respect to FIGS. 2, 3, and 5, the detection system 204 may detect a target vehicle and generate detection output 312. For example, the detection output 312 may include a confidence score. In some examples, the detection output 312 may additionally include support information. For example, the support information may include captured video clips, time, location, direction, etc.

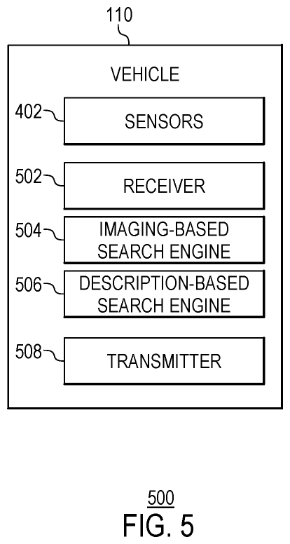

FIG. 5 is a block diagram of an example vehicle for detecting vehicles using non-standard features. The system 500 of FIG. 5 includes a vehicle 110 having a number of sensors 402. For example, the sensors 402 may include camera sensors, RADAR sensors, LiDAR sensors, or any combination thereof. In various examples, the sensors 402 may be located on the top, bottom, front, side, or rear of the vehicle. The sensors may be installed on the vehicle to sense light from outside the vehicle. The vehicle 110 further includes a receiver 502, an imaging-based search engine 504, a description-based search engine 506, and a transmitter 508. In some examples, the receiver 502 and transmitter 508 may be a single transceiver.

The receiver 502 can receive a detection request. For example, the receiver 502 may receive the detection request within a geographical area of interest associated with the detection request. In various example, the detection request may include non-standard features. In some examples, the detection request may also further include standard features.

The imaging-based search engine 504 can execute an image-based search in response to detecting an image in the detection request. For example, the imaging-based search engine 504 may be a neural network trained on annotated images to detect similar images. In various examples, the imaging-based search engine 504 may receive an image from the receiver 502 and continuously process images from sensors 402 to output detections whenever a frame or image from the sensors 402 matches the image from the receiver 502 above a particular confidence score threshold.

The description-based search engine 506 can execute a description-based search in response to detecting a text description in the detection request. For example, the description-based search engine 506 may be a neural network trained on text annotated with images to match images with text descriptions of non-standard or standard features.

The transmitter 508 can transmit a detection output. For example, the detection output may include a confidence score indicating the probability that a detected vehicle is the target vehicle being searched for. In addition, the detection output may include support information. In some examples, the support information may include a video clip saved from the time that a target vehicle is detected. For example, the video clip may be of a particular duration. In some examples, the video clip may be of a length determined by the presence of the target vehicle in the frames. In various examples, the support information may include location data, such as GPS coordinates of the vehicle 110 at the time of detection.

It will be appreciated the detection scenarios and techniques for conveying detection information described herein are only examples. Various additional techniques for conveying vehicle detection information through the use of non-standard features can be implemented depending on the design considerations of a particular implementation and the particular scenarios to be addressed. For example, additional AI models, types of data and search engines, sensors, vehicles may be used in various examples. In various examples, each of any number of AI models may be trained for a particular input signal modality.

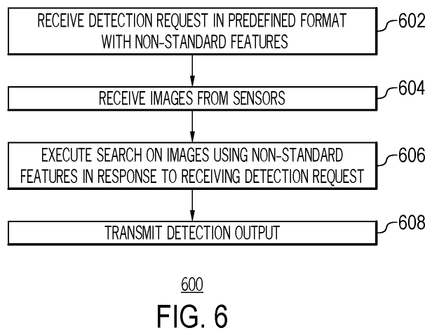

FIG. 6 is a process flow diagram for an example method of detecting vehicles using non-standard features, in accordance with embodiments. As described above, the connected vehicle includes a detection system. The method 600 may be performed by logic implemented in the detection system alone or combination with other processing units in a vehicle. The logic is embodied in hardware, such as logic circuitry or one or more processors configured to execute instructions stored in a non-transitory, computer-readable medium. The process may begin at block 602.

At block 602, a detection request in a predefined format with non-standard features is received. For example, the detection request may be received over a V2X channel. In various examples, the detection request may include images or video. In some examples, the detection request may include a text description of non-standard features. In various examples, the non-standard features may be features of the target vehicle such as noticeable vehicle body features, custom modifications, or optional features, among other features that are non-standard for alerts, such as AMBER alerts. For example, the non-standard feature may have been noticed and reported by people such as bystanders or any other source. In some examples, the detection request may also include standard features, such as year, make, model, and license plate or tag information. In various example, the detection request may be received within a geographical area of interest associated with the detection request.

At block 604, images are received from sensors. For example, the images may be received from a continuous camera, RADAR, or LiDAR feed.

At block 606, a search is executed on the images using the non-standard features in response to receiving the detection request. In some examples, the search may be an imaging-based search, a description-based search, or a combination thereof. For example, an imaging-based search via a machine learning model trained for image-based search may be executed in response to detecting an image in the detection request. In some examples, a description-based search via an AI model trained for text-based search may be executed in response to detecting text in the detection request. In various examples, the search may also be executed using standard features in addition to the non-standard features. In some examples, the search may be executed locally via a processor of the vehicle. In some examples, some or all of the search may be executed via a cloud service.

At block 608, detection output is transmitted. For example, a detected target vehicle may be transmitted to a source of the detection request. In some examples, additional support information may also be transmitted. For example, the additional support information may include capture video clips including the detected target vehicle, a location of the detecting vehicle, among other information.

The method 600 should not be interpreted as meaning that the blocks are necessarily performed in the order shown. Furthermore, fewer or greater actions can be included in the method 600 depending on the design considerations of a particular implementation.

While the invention may be susceptible to various modifications and alternative forms, specific embodiments have been shown by way of example. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A system in a vehicle for detecting target vehicles comprising:
a sensor installed on the vehicle to sense light from outside the vehicle;
a transceiver installed in the vehicle, the transceiver to receive a detection request and transmit a detection output; and
a detection system installed in the vehicle, the detection system comprising a processor to:
receive the detection request from the transceiver, wherein the detection request comprises non-standard features;
receive an image from a sensor;
execute a search on the image using the non-standard features in response to receiving the detection request; and
send the detection output corresponding to a detected target vehicle to the transceiver.

2. The system of claim 1, wherein the vehicle is to receive the detection request within a geographical area of interest associated with the detection request.

3. The system of claim 1, wherein the search comprises an imaging-based search, wherein the processor is to execute the imaging-based search in response to detecting an image in the detection request.

4. The system of claim 1, wherein the search comprises a description-based search, wherein the processor is to execute the description-based search in response to detecting a text description in the detection request.

5. The system of claim 1, wherein the detection system comprises a plurality of pre-trained machine learning models, wherein each of the machine learning models is trained for a particular input signal modality.

6. The system of claim 1, wherein the detection output further comprises support information.

7. The system of claim 1, wherein the detection system comprises a neural network trained to detect target vehicles based on non-standard features.

8. The system of claim 1, wherein the sensor comprises a camera.

9. The system of claim 1, comprising sensor comprises a radio detection and ranging (RADAR) sensor.

10. The system of claim 1, wherein the sensor comprises a light detection and ranging (LiDAR) sensor.

11. A method for detecting target vehicles at a vehicle comprising:
receiving a detection request from a transceiver, wherein the detection request comprises non-standard features;
receiving an image from a sensor;
executing a search on the image using the non-standard features in response to receiving the detection request; and
transmitting a detection output corresponding to a detected target vehicle to the transceiver.

12. The method of claim 11, wherein the search is executed locally via a processor of the vehicle.

13. The method of claim 11, wherein the image is received at a cloud service and the search is executed via the cloud service.

14. The method of claim 11, comprising receiving the detection request within a geographical area of interest associated with the detection request.

15. The method of claim 11, comprising executing an imaging-based search via a machine learning model trained for image-based search in response to detecting an image in the detection request.

16. The method of claim 11, comprising executing a description-based search via a machine learning model trained for text-based search in response to detecting text in the detection request.

17. A system for detecting target vehicles comprising:
a processor to:
receive a detection request from a transceiver, wherein the detection request comprises non-standard features;
receive an image from a sensor;
execute a search on the image using the non-standard features in response to receiving the detection request; and
transmit detection output corresponding to a detected target vehicle via the transceiver.

18. The system of claim 17, wherein the processor comprises a cloud computing processor.

19. The system of claim 17, wherein the processor comprises a processor in a vehicle.

20. The system of claim 17, wherein the sensor is installed in a vehicle within a geographical area of interest associated with the detection request.
